(19) United States
(12) Patent Application Publication
(10) Pub. No.: US 2023/0054108 A1
(43) Pub. Date: Feb. 23, 2023

(54) ELECTRONIC APPARATUS AND CONTROL METHOD THEREOF

(71) Applicant: Samsung Electronics Co., Ltd., Suwon-si (KR)

(72) Inventor: Dongseob KIM, Suwon-si (KR)

(21) Appl. No.: 17/854,905

(22) Filed: Jun. 30, 2022

Related U.S. Application Data
(63) Continuation of application No. PCT/KR2022/008232, filed on Jun. 10, 2022.

(30) Foreign Application Priority Data
Aug. 20, 2021 (KR) 10-2021-0110467

(51) Int. Cl. G06V 40/16; G06V 10/82; G06V 40/20; G06F 16/55

(52) U.S. Cl. CPC G06V 40/16; G06V 10/82; G06V 40/20; G06F 16/55; G06V 2201/10

(57) ABSTRACT

An electronic apparatus is provided. The electronic apparatus includes a memory that stores image information and identification information, corresponding to each of a plurality of persons, and a processor that inputs a captured image to a neural network model to obtain a plurality of person images included in the captured image and relationship information between the plurality of person images, obtains first identification information corresponding to a first person image and second identification information corresponding to a second person image, among the plurality of person images, based on the image information, obtains group information including the first identification information and the second identification information, based on the relationship information, and provides recommendation information related to the person corresponding to each of the first identification information and the second identification information among the plurality of persons, based on the obtained group information.

### CROSS-REFERENCE TO RELATED APPLICATION(S)

This application is a continuation application, claiming priority under § 365(c), of an International application No. PCT/KR2022/008232, filed on Jun. 10, 2022, which is based on and claims the benefit of a Korean patent application number 10-2021-0110467, filed on Aug. 20, 2021, in the Korean Intellectual Property Office, the disclosure of which is incorporated by reference herein in its entirety.

### BACKGROUND

### 1. Field

The disclosure relates to an electronic apparatus and a control method thereof More particularly, the disclosure relates to an electronic apparatus that obtains information from an image, and a control method thereof.

### 2. Description of the Related Art

Various types of electronic devices are being developed and supplied recently as electronic technology is developed.

In particular, a user terminal device may include a camera. A user can therefore take a photo with attendees at various meetings he or she attends by using the user terminal device, and the user terminal device may thus store, maintain and manage the plurality of images taken by the user.

Meanwhile, it is rather bothersome for the user to manually set a person in intimacy with him/her by using a social network service (SNS) application. An external device (e.g., server) instead of the user terminal device may analyze user-related data (e.g., an image or a user usage history) to automatically identify the person familiar with the user himself/herself. In this case, there is a risk in which the user-related data and personal information may leak to the outside.

There thus has been a demand for a method in which the user terminal device can identify the person or a group (i.e., persons), having intimacy with the user by analyzing the plurality of images by itself without the hassle or the information leakage risk.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus that obtains information on a group corresponding to people included in an image, and a control method thereof.

Additional aspects will be set forth in part in the description which follows and, in part, will be apparent from the description, or may be learned by practice of the presented embodiments.

In accordance with an aspect of the disclosure, an electronic apparatus is provided. The electronic apparatus includes a memory that stores image information and identification information, corresponding to each of a plurality of persons, and a processor configured to input a captured image to a neural network model to obtain a plurality of person images included in the captured image and relationship information between the plurality of person images, obtain first identification information corresponding to a first person image and second identification information corresponding to a second person image, among the plurality of person images, based on the image information, obtain group information including the first identification information and the second identification information, based on the relationship information, and provide recommendation information related to the person corresponding to each of the first identification information and the second identification information among the plurality of persons, based on the obtained group information.

Here, if an event including any one of the first identification information or the second identification information is generated in a specific application, based on a user command, the processor may provide the rest of the first identification information or the second identification information as the recommendation information for the event.

Here, if a scheduling event including any one of the first identification information or the second identification information is generated in the specific application, based on the user command, the processor may provide the rest of the first identification information or the second identification information as the recommendation information for the scheduling event.

In addition, if an event for transmitting a message to any one of the first identification information or the second identification information is generated in the specific application, based on the user command, the processor may provide the rest of the first identification information or the second identification information as the recommendation information for sharing the message.

In addition, the processor may identify the captured image including all the images, respectively corresponding to the first identification information and the second identification information, among the captured images stored in the electronic apparatus, and manage the captured image by assigning a tag, corresponding to the obtained group information, to the identified captured image.

In addition, if the captured image including both the first person image and the second person image is identified among the plurality of captured images stored in the memory by a threshold number or more, the processor may obtain the group information including the first identification information and the second identification information, based on the relationship information.

In addition, the neural network model may be a model trained to obtain the relationship information between the plurality of person images, based on at least one of the attire, pose or facial expression of the person included in the plurality of person images or object information included in an input image, if the plurality of person images are identified in the input image.

In addition, the neural network model is a model trained to identify an action type corresponding to the input image, based on the relationship information between background information included in the input image and the person image included in the input image, and the processor may obtain action type information corresponding to the captured image by inputting the captured image to the neural network model, and manage the captured image by assigning the obtained action type information to the captured image, as a tag.

In addition, the processor may obtain at least one information on the place, date or time at which the captured image is captured, based on metadata included in the captured image, and provide the obtained information as the recommendation information related to the person corresponding to each of the first identification information and the second identification information.

In addition, the processor may obtain the group information including the first identification information or the second identification information if at least one of the first identification information or the second identification information corresponds to a user of the electronic apparatus, and may not obtain the group information including the first identification information or the second identification information if none of the first identification information or the second identification information corresponds to the user of the electronic apparatus.

In accordance with another aspect of the disclosure, a control method of an electronic apparatus including image information and identification information, corresponding to each of a plurality of persons, is provided. The control method includes inputting a captured image to a neural network model to obtain a plurality of person images included in the captured image and relationship information between the plurality of person images, obtaining first identification information corresponding to a first person image and second identification information corresponding to a second person image, among the plurality of person images, based on the image information, obtaining group information including the first identification information and the second identification information, based on the relationship information, and providing recommendation information related to the person corresponding to each of the first identification information and the second identification information, among the plurality of persons, based on the obtained group information.

Here, if an event including any one of the first identification information or the second identification information is generated in a specific application, based on a user command, the providing of the recommendation information may include providing the rest of the first identification information or the second identification information as the recommendation information for the event.

Here, if a scheduling event including any one of the first identification information or the second identification information is generated in the specific application, based on the user command, the providing of the recommendation information may include providing the rest of the first identification information or the second identification information as the recommendation information for the scheduling event.

In addition, wherein if an event for transmitting a message to any one of the first identification information or the second identification information is generated in the specific application, based on the user command, the providing of the recommendation information may include providing the rest of the first identification information or the second identification information as the recommendation information for sharing the message.

In addition, the control method may further include identifying the captured image including all the images respectively corresponding to the first identification information and the second identification information among the captured images stored in the electronic apparatus, and managing the captured image by assigning a tag, corresponding to the obtained group information, to the identified captured image.

In addition, if the captured image including both the first person image and the second person image is identified among the plurality of captured images by a threshold number or more, the obtaining of the group information may include obtaining the group information including the first identification information and the second identification information, based on the relationship information.

In addition, the neural network model may be a model trained to obtain the relationship information between the plurality of person images, based on at least one of the attire, pose or facial expression of the person included in the plurality of person images or object information included in an input image, if the plurality of person images are identified in the input image.

In addition, the neural network model may be a model trained to identify an action type corresponding to the input image, based on the relationship information between background information included in the input image and the person image included in the input image, and the control method may further include obtaining action type information corresponding to the captured image by inputting the captured image to the neural network model, and manage the captured image by assigning the obtained action type information to the captured image, as a tag.

In addition, the control method may further include obtaining at least one information on the place, date or time at which the captured image is captured, based on metadata included in the captured image, in which the providing of the recommendation information may include providing the obtained information as the recommendation information related to the person corresponding to each of the first identification information and the second identification information.

In addition, the obtaining of the group information may include obtaining the group information including the first identification information or the second identification information if at least one of the first identification information or the second identification information corresponds to a user of the electronic apparatus, and may not include obtaining the group information including the first identification information or the second identification information if none of the first identification information or the second identification information corresponds to the user of the electronic apparatus.

According to various embodiments of the disclosure, it is possible to automatically analyze the captured image to identify the plurality of persons included in the captured image.

In addition, it is possible to group the identified plurality of persons into one group, obtain information on the group, and generate the group information.

In addition, it is possible to provide the recommendation information in various applications using the group information.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and/or other aspects, features, and advantages of certain embodiments of the disclosure will be more apparent from the following description taken in conjunction with the accompanying drawings, in which:

FIG. 1 is a block diagram showing a configuration of an electronic apparatus according to an embodiment of the disclosure;

FIG. 2 is a view showing a method of obtaining relationship information according to an embodiment of the disclosure;

FIG. 3 is a view showing group information according to an embodiment of the disclosure;

FIG. 4 is a view showing image information according to an embodiment of the disclosure;

FIG. 5 is a view showing a method of identifying an action type according to an embodiment of the disclosure;

FIG. 6 is a view showing metadata according to an embodiment of the disclosure;

FIG. 7 is a view showing a method of obtaining gender and age according to an embodiment of the disclosure;

FIG. 8 is a view showing group information according to an embodiment of the disclosure;

FIG. 9 is a view showing a method of obtaining group information according to an embodiment of the disclosure; and

FIG. 10 is a flowchart showing a control method of the electronic apparatus according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

Terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Terms “first,” “second”, and the like, may be used to describe various components, but the components are not to be construed as being limited by these terms. The terms are used only to distinguish one component from another component.

It is to be understood that a term “include” or “formed of” used in the specification specifies the presence of features, numerals, steps, operations, components, parts or combinations thereof, which is mentioned in the specification, and does not preclude the presence or addition of one or more other features, numerals, steps, operations, components, parts or combinations thereof.

In the embodiments, a “module” or a “˜er/˜or” may perform at least one function or operation, and be implemented by hardware or software or be implemented by a combination of hardware and software. In addition, a plurality of “modules” or a plurality of “˜ers/˜ors” may be integrated in at least one module and be implemented by at least one processor (not illustrated) except for a “module” or a “˜er/or” that needs to be implemented by a specific hardware.

Hereinafter, embodiments of the disclosure will be described in detail with reference to the accompanying drawings so that those skilled in the art to which the disclosure pertains may easily practice the disclosure. However, the disclosure may be modified in various different forms, and is not limited to embodiments provided in the specification. In addition, in the drawings, portions unrelated to the description are omitted to clearly describe the disclosure, and similar portions are denoted by similar reference numerals throughout the specification.

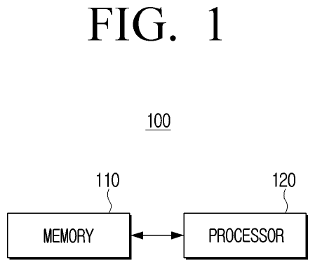

FIG. 1 is a block diagram showing a configuration of an electronic apparatus according to an embodiment of the disclosure.

Referring to FIG. 1, the electronic apparatus according to an embodiment of the disclosure may be implemented as any of various types of devices, such as a user terminal device, a display apparatus, a set-top box, a tablet personal computer (PC), a smartphone, an e-book reader, a desktop PC, a laptop PC, a workstation, a server, a personal digital assistant (PDA), a portable multimedia player (PMP), a moving picture experts group (MPEG) audio layer-3 (MP3) player or a kiosk. However, this device may be an embodiment, and the electronic apparatus 100 may be implemented as any of various types of electronic apparatuses such as a wearable device corresponding to at least one of an accessory type (e.g., watch, ring, bracelet, anklet, necklace, glasses or contact lens), a head-mounted-device (HMD)) or a textile/clothing integral type (e.g., electronic clothing), a robot including a driver, a projector or a server.

In some embodiments, the electronic apparatus 100 may include, for example, at least one of a television, a digital video disk (DVD) player, an audio player, a refrigerator, an air conditioner, a vacuum cleaner, an oven, a microwave oven, a washing machine, an air purifier, a set-top box, a home automation control panel, a security control panel, a media box (e.g., Samsung HomeSync™, Apple TV™ or Google TV™), a game console (e.g., Xbox™ or PlayStation™), an electronic dictionary, an electronic key, a camcorder or an electronic picture frame.

In another embodiment, the electronic apparatus 100 may include at least one of various medical devices (e.g., various portable medical devices (such as a blood glucose monitor, a heart rate monitor, a blood pressure monitor or a body temperature monitor), a magnetic resonance angiography (MRA), a magnetic resonance imaging (MRI), a computed tomography (CT), a camera or a ultrasonicator)), a navigation device, a global positioning system (i.e. global navigation satellite system (GNSS)), an event data recorder (EDR), a flight data recorder (FDR), an automotive infotainment device, marine electronic equipment (e.g., a marine navigation system and a gyro compass), an avionics, a security device, a vehicle head unit, an industrial or home robot, a drone, an automated teller machine (ATM) in a financial institution, a point of sales (POS) in a store or an internet of things device (e.g., a light bulb, various sensors, a sprinkler device, a fire alarm, a thermostat, a street light, a toaster, fitness equipment, a hot water tank, a heater or a boiler).

Referring to FIG. 1, the electronic apparatus 100 is assumed to be the user terminal device for convenience of explanation.

A memory 110 according to an embodiment may be a component variably storing various information for a function of the electronic apparatus 100. For example, the memory 110 may be implemented as a non-volatile memory such as a hard disk, a solid state drive (SSD) or a flash memory (e.g., NOR flash memory or NAND flash memory).

The memory 110 may store one or more artificial intelligence models. In detail, the memory 110 according to the disclosure may store a neural network model trained to identify a person image (or person region) in an image, and to identify relationship information between the plurality of person images if the plurality of images are identified in the image.

For example, the neural network model stored in the memory 110 may be a model trained to identify a region (hereinafter, person image) which includes a person (or human) in the image. Here, the neural network model may be a model trained to identify the person image using a plurality of sample images.

In addition, the neural network model may be a model trained to obtain the relationship information between the plurality of person images identified in the image. For example, the neural network model may identify that the relationship between the plurality of person images corresponds to any one of a friend relationship, a family relationship, a couple relationship, a commercial relationship, a professional relationship or no relationship.

The neural network model according to an embodiment may be a decision model trained based on a plurality of images, using an artificial intelligence algorithm, and may be a model based on a neural network. The trained decision model may be designed to simulate a human brain structure on a computer, and may include a plurality of network nodes each having a weight and simulating a neuron of a human neural network. The plurality of network nodes may have a connection relationship therebetween to simulate a synaptic activity of the neuron transmitting and receiving a signal through a synapse. In addition, the trained decision model may include, for example, a machine learning model, a neural network model or a deep learning model developed from a neural network model. As for the deep learning model, the plural of network nodes may be positioned at different depths (or layers), and may transmit and receive data therebetween based on a convolution connection relationship.

For example, the neural network model may be a convolutional neural network (CNN) model trained based on an image. The convolutional neural network (CNN) may be a multilayer neural network having a special connection structure designed for speech processing and image processing. Meanwhile, the neural network model may not be limited to the CNN. For example, the neural network model may be implemented as a deep neural network (DNN) model of at least one of a recurrent neural network (RNN), a long short term memory network (LSTM), a gated recurrent unit (GRU) network or a generative adversarial network (GAN).

The memory 110 according to an embodiment of the disclosure may store image information and identification information, corresponding to each of a plurality of persons. Here, the image information may indicate a representative image corresponding to the person, and the identification information may indicate a name, a nickname, a unique number or the like, that can identify the person.

For example, the memory 110 may store a contact management application, and the contact management application may include the image information, the identification information, a phone number, an address, an affiliation (or group), the relationship (e.g., parent, spouse, child, friend, partner or the like), an e- mail address and the like, corresponding to each of the plurality of persons.

The processor 120 according to an embodiment may control an overall operation of the electronic apparatus 100.

The processor 120 according to an embodiment may be implemented as a digital signal processor (DSP) that processes a digital video signal, a microprocessor, an artificial intelligence (AI) processor or a timing controller (T-CON). However, the processor 120 is not limited thereto, and may include one or more of a central processing unit (CPU), a micro controller unit (MCU), a micro processing unit (MPU), a controller, an application processor (AP), a communication processor (CP) or an advanced RISC machine (ARM) processor, or may be defined by these terms. In addition, the processor 120 may be implemented as a system-on-chip (SoC) or a large scale integration (LSI), in which a processing algorithm is embedded, or may be implemented in the form of a field programmable gate array (FPGA).

In particular, the processor 120 may input the image to the neural network model to obtain the plurality of person images included in the image and the relationship information between the plurality of person images.

Here, the image may indicate a captured image photographed and obtained by a camera (not shown) positioned in the electronic apparatus 100, or a captured image received from an external electronic apparatus.

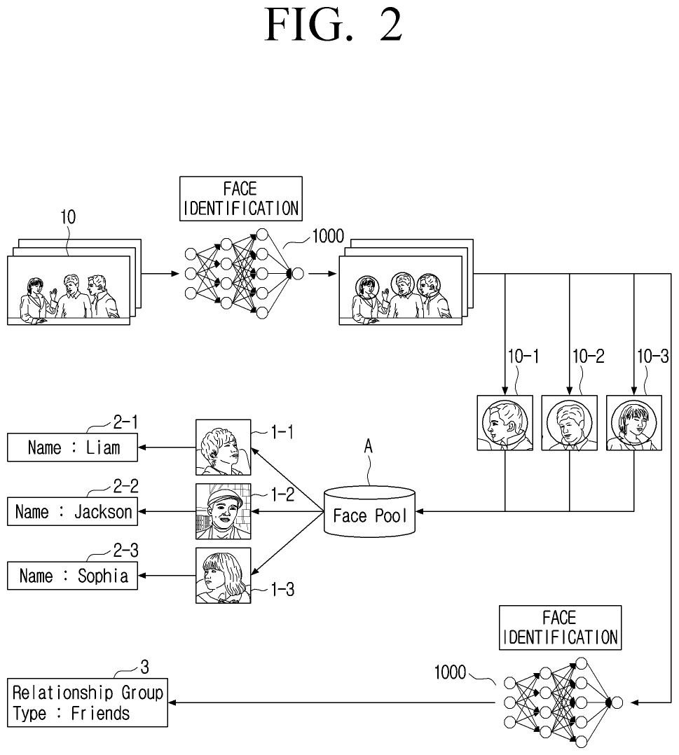

The neural network model may obtain the plurality of person images included in the captured image, and can obtain the relationship information between the plurality of person images. The description describes this manner in detail with reference to FIG. 2.

FIG. 2 is a view showing a method of obtaining relationship information according to an embodiment of the disclosure.

Referring to FIG. 2, the processor 120 may input a captured image 10 to a neural network model 1000. The neural network model 1000 may then obtain a plurality of person images 10-1 to 10-3 included in the captured image 10. The processor 120 according to an embodiment of the disclosure may obtain the identification information corresponding to each of the plurality of person images 10-1 to 10-3 obtained in the captured image 10, based on image information (e.g., face pool) A corresponding to each of the plurality of persons stored in the memory 110.

For example, the processor 120 may compare the first person image 10-1, obtained from captured image 10, with the image information (e.g., face pool) A, corresponding to each of the plurality of persons and stored in the memory 110, to obtain image information 1-1 corresponding to a first person similar to the first person image 10-1 by a threshold value or more, and to obtain first identification information 2-1 corresponding to the first person.

For another example, the processor 120 may compare the second person image 10-2, obtained from the captured image 10, with the image information A, corresponding to each of the plurality of persons and stored in the memory 110, to obtain image information 1-2 corresponding to a second person similar to the second person image 10-2 by the threshold value or more, and to obtain second identification information 2-2 corresponding to the second person.

For convenience of explanation, FIG. 2 shows a case of obtaining a total of three person images in the captured image and obtaining the image information 1-1 to 1-3 and the identification information 2-1 to 2-3 of the three persons. However, this case is an example and the disclosure may not be limited thereto. For another example, the neural network model can obtain the plurality of person images of two or more persons included in the captured image.

In addition, the processor 120 may input the captured image 10 to the neural network model 1000 to obtain relationship information 3 between the plurality of person images.

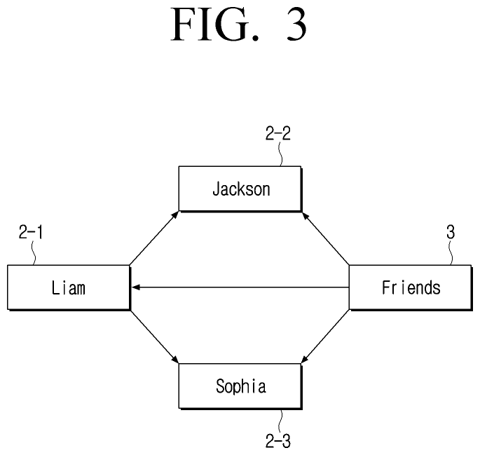

Referring to FIG. 3, the neural network model 1000 may be a model trained to obtain the relationship information 3 between the plurality of person images, based on the plurality of person images included in the captured image 10, i.e. based on at least one of the attire, pose or facial expression of the person or object information included in the captured image 10.

The processor 120 may then obtain group information including the first identification information 2-1 to the third identification information 2-3, based on the relationship information 3.

The description describes the group information in detail with reference to FIG. 3.

FIG. 3 is a view showing the group information according to an embodiment of the disclosure.

Referring to FIG. 3, the processor 120 can obtain group information by generating, in one graph, the first identification information 2-1 to the third identification information 2-3 and relationship information 3, obtained from captured image 10.

Here, the graph form is only an example, and the processor 120 may obtain any of various forms of group information by mapping the first identification information 2-1 to the third identification information 2-3 and the relationship information 3 together. For example, the processor 120 may also obtain the group information in a table form by mapping the first identification information 2-1 to the third identification information 2-3 and the relationship information 3 together.

That is, the processor 120 may obtain the group information, representing the plurality of persons included in the captured image and the relationship between the plurality of persons, in the graph form (e.g., see FIG. 3).

The processor 120 may then provide recommendation information related to the person corresponding to each of the first identification information to the third identification information among the plurality of persons, based on the group information.

For example, if an event including any one of the first identification information 2-1 to the third identification information 2-3 is generated in a specific application, based on a user command, the processor 120 may provide the rest of the first identification information 2-1 to the third identification information 2-3 as the recommendation information for the event. For convenience of explanation, the description assumes that the first identification information 2-1 is the first person (e.g., Liam), the second identification information 2-2 is the second person (e.g., Jackson) and the third identification information 2-3 is a third person (e.g., Sophia), with reference to FIG. 3.

If a scheduling event including any one of the first identification information 2-1 to the third identification information 2-3 is generated in the specific application, based on the user command, the processor 120 according to an embodiment may provide the rest of the first identification information 2-1 to the third identification information 2-3 as the recommendation information for the scheduling event.

For example, if a scheduling event including the first person (e.g., Liam) as its participant is generated in an application (e.g., schedule management application) that generates the scheduling event, the processor 120 may provide, as the recommendation information, a user interface (UI) that asks whether to add the second person (e.g., Jackson) and the third person (e.g., Sophia) as other participants of the corresponding scheduling event, based on the group information.

For another example, if a scheduling event including a person corresponding to a friend relationship as its participant is generated in the application that generates the scheduling event, the processor 120 may provide, as the recommendation information, a user interface (UI) that asks whether to add the first person (e.g., Liam), the second person (e.g., Jackson) and the third person (e.g., Sophia) as the participants of the corresponding scheduling event, based on the group information. For yet another example, if a scheduling event including a person corresponding to a friend relationship as its participant is generated in the application that generates the scheduling event, the processor 120 may automatically add the first person (e.g., Liam), the second person (e.g., Jackson) and the third person (e.g., Sophia) as the participants of the corresponding scheduling event, based on the group information.

If a message transmission event having any one of the first identification information 2-1 to the third identification information 2-3 as its recipient is generated in the specific application, based on the user command, the processor 120 according to an embodiment may provide the rest of the first identification information 2-1 to the third identification information 2-3 as the recommendation information for the corresponding message transmission event.

For example, if a message transmission event having the first person (e.g., Liam) as its recipient is generated in an application (e.g., social network service (SNS) application) that generates the message transmission event, the processor 120 may provide, as the recommendation information, a UI that asks whether to add the second person (e.g., Jackson) and third person (e.g., Sophia) as other recipients of the message transmission event, based on the group information.

For another example, if a message transmission event having a person corresponding to a friend relationship as its participant is generated in a social network service (SNS) application, the processor 120 may provide, as the recommendation information, a user interface (UI) that asks whether to add the first person (e.g., Liam), the second person (e.g., Jackson) and the third person (e.g., Sophia) as the recipients of the corresponding message transmission event, based on the group information. For yet another example, if a chatting event having a person corresponding to a friend relationship as its participant is generated in the SNS application, the processor 120 may automatically add the first person (e.g., Liam), the second person (e.g., Jackson) and the third person (e.g., Sophia) as the participants of the corresponding chatting event, based on the group information.

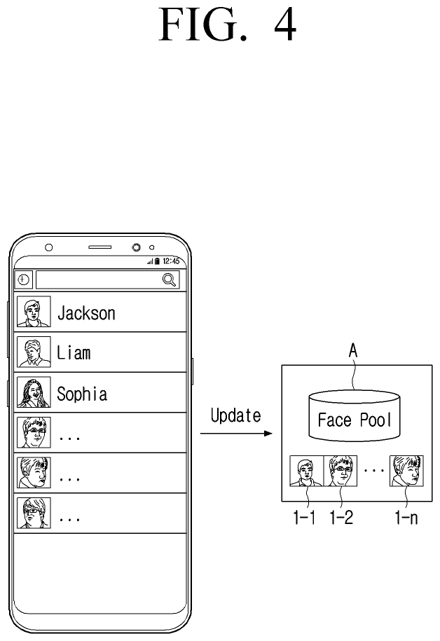

FIG. 4 is a view showing image information according to an embodiment of the disclosure.

Referring to FIG. 4, the memory 110 may store the image information A corresponding to each of the plurality of persons. For example, the processor 120 may obtain the image information A corresponding to each of the plurality of persons, based on the contact management application (e.g., phone book application), and may allow the memory 110 to store the obtained image information A. For example, the processor 120 may obtain image information and identification information, corresponding to a person, newly stored in the contact management application in real time or at a regular interval, to update the image information A corresponding to each of the plurality of persons.

Referring to FIG. 4, the memory 110 may store the first image information 1-1 and the first identification information 2-1, corresponding to the first person, the second image information 1-2 and the second identification information 2-2, corresponding to the second person, and n-th image information 1-n and n-th identification information 2-n, corresponding to an n-th person.

According to an embodiment of the disclosure, the processor 120 may obtain the group information, representing the plurality of persons included in the captured image and the relationship between the plurality of persons, in the graph form (e.g., see FIG. 3).

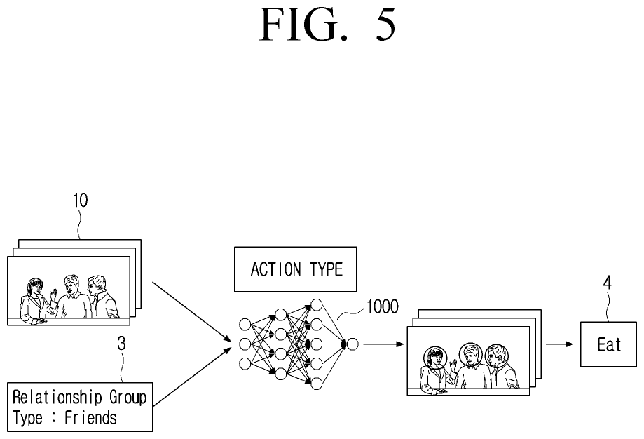

Meanwhile, according to an embodiment, the processor 120 may obtain various information in addition to the information for the plurality of persons included in the captured image and the relationship between the plurality of persons, and may obtain the group information in which the various information is added to the graph form. The description describes this manner in detail with reference to FIGS. 5 to 8.

FIG. 5 is a view showing a method of identifying an action type according to an embodiment of the disclosure.

Referring to FIG. 5, the neural network model 1000 may be a model trained to identify an action type corresponding to the sample image, based on background information of the sample image (e.g., trained image) and the relationship information between the plurality of person images included in the sample image.

For example, the neural network model 1000 may identify an action of the plurality of persons in the sample image, i.e. situation in the sample image, corresponds to which action type information (i.e., action or situation) such as sport, disaster, crime, convention, election, ceremony, event, celestial event, protest, eating or study.

The processor 120 may then obtain action type information 4 corresponding to the captured image 10 by inputting the captured image 10 to the neural network model 1000.

The processor 120 may then obtain the group information in any of various forms (e.g., graph form) by mapping the first identification information 2-1 to the third identification information 2-3, the relationship information 3 and the action type information 4 together.

The processor 120 according to an embodiment can manage the captured image 10 by assigning the obtained action type information 4 to the captured image 10, as a tag. Here, a method of managing the captured image 10 may include a method of managing images assigned with the same tag as one folder by using an image management application (e.g., photo album application), a method of managing the captured image 10 to be retrievable using the tag, etc.

Meanwhile, in an embodiment shown in FIG. 5, the processor 120 inputs the captured image 10 to the neural network model 1000 to obtain the action type information 4 corresponding to the captured image 10, and may not be limited thereto.

For example, the processor 120 may obtain the action type information 4 corresponding to the captured image 10, based on captured date and time (e.g., date, time and time zone) included in metadata on the captured image 10. A specific example of the metadata is described below.

For example, if the captured date is a weekday, and the captured time is office hour or daytime, the processor 120 can identify or predict a work performance, a meeting or the like as the action type information 4 corresponding to the captured image 10.

For another example, if the captured date is a weekend, the processor 120 can identify or predict leisure activity, travel, rest or the like as the action type information 4 corresponding to the captured image 10.

According to an embodiment, the processor 120 may obtain the action type information 4 by inputting the captured image 10 and the metadata on the captured image 10 to the neural network model 1000, or may obtain the action type information 4 corresponding to the captured image 10 by considering both the action type information 4 obtained from the neural network model 1000 and the action type information 4 predicted based on the metadata on the captured image 10.

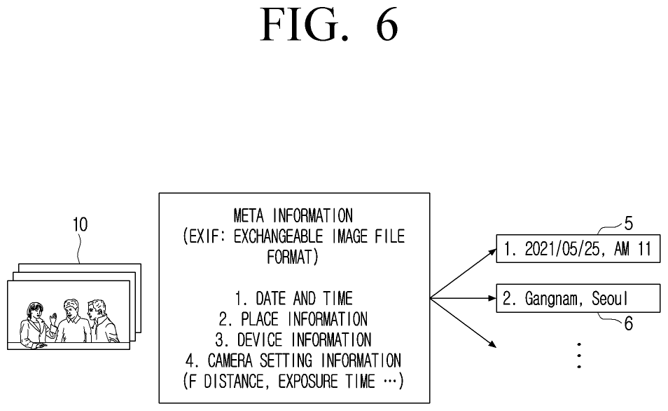

FIG. 6 is a view showing the metadata according to an embodiment of the disclosure.

Referring to FIG. 6, the metadata may be included in the captured image 10 captured and obtained by the electronic apparatus 100 by itself or the captured image received from the external electronic apparatus.

Here, the metadata may include the captured date and time (e.g., date, time and time zone), camera information (i.e. camera information and device Information, e.g., camera model and manufacturer), camera settings information (e.g., focal length, flash use/non-use, aperture and shutter speed), orientation, geolocation (e.g., global positioning system (GPS)), thumbnail, description (e.g., tag), image rights information (e.g., copyright) and the like, and the metadata may have various forms, such as exchangeable image file format (EXIF), extensible metadata platform (XMP), international press telecommunications council—information interchange model (IPTC-IIM), etc.

The processor 120 according to an embodiment may obtain information related to the captured image 10, such as a date and time 5 or a day, a place 6 or the like, at which the captured image 10 is captured, based on the metadata. The processor 120 may then obtain the group information in any of various forms (e.g., graph form) by mapping the first identification information 2-1 to the third identification information 2-3, the relationship information 3, information related to the captured image 10 and the like together.

Meanwhile, the processor 120 may provide the recommendation information related to the person corresponding to each of the first identification information 2-1 to the third identification information 2-3, based on the information related to the captured image 10 or the group information.

For example, if the scheduling event is generated on a specific date and time or day, based on the user command in the application that generates the scheduling event, the processor 120 may provide, as the recommendation information, a UI that asks whether to add the first person (e.g., Liam), the second person (e.g., Jackson) and the third person (e.g., Sophia) as participants of the corresponding scheduling event, based on the group information including the corresponding date and time 5 or day, place 6, etc.

For another example, if the scheduling event is generated on the specific date and time or day, the processor 120 may automatically add the first person (e.g., Liam), the second person (e.g., Jackson) and the third person (e.g., Sophia) as the participants of the corresponding scheduling event, based on the group information including the corresponding date and time 5 or day, place 6, etc.

Meanwhile, in the above embodiment, the processor 120 may obtain image information 1, identification information 2, the relationship information 3, the action type 4, the date and time 5 or the day, the place 6 and the like, based on only one captured image 10, and can then obtain the group information based thereon.

However, the processor 120 is not limited thereto, and may obtain the group information in a case satisfying a specific condition. For example, if the first identification information 2-1 to the third identification information 2-3 are identified among the plurality of captured images stored in the memory 110 by a threshold number of times or more, the processor 120 may obtain the group information by mapping the first identification information 2-1 to the third identification information 2-3 and the relationship information 3 together. Here, the threshold number of times may be variously set to be 5 times, 10 times or the like for example, based on the user, manufacturer, etc.

In addition, the processor 120 may classify the identified images each including the first identification information 2-1 to third identification information 2-3 among the plurality of captured images stored in the memory 110, and may then obtain the group information among the classified images, based on the action type 4, the date and time 5 or the day, the place 6 or the like, obtained for the threshold number of times or more by the neural network model or the metadata.

For example, if the group information is obtained based on only one captured image obtained from one meeting, there is a low possibility that the processor 120 provides the recommendation information by using the corresponding group information.

On the contrary, if the group information is obtained based on a plurality of captured images obtained from several meetings, there is a high possibility that the first identification information 2-1 to the third identification information 2-3, included in the group information, each have intimacy with the user, or the scheduling event is generated to involve the first identification information 2-1 to the third identification information 2-3. There is thus a high probability that the processor 120 provides the recommendation information by using the group information. If specific identification information (e.g., first identification information 2-1 to third identification information 2-3) are identified by the threshold number of times or more, among the plurality of captured images, the processor 120 according to an embodiment may thus generate the group information by mapping the identification information with the relationship information 3.

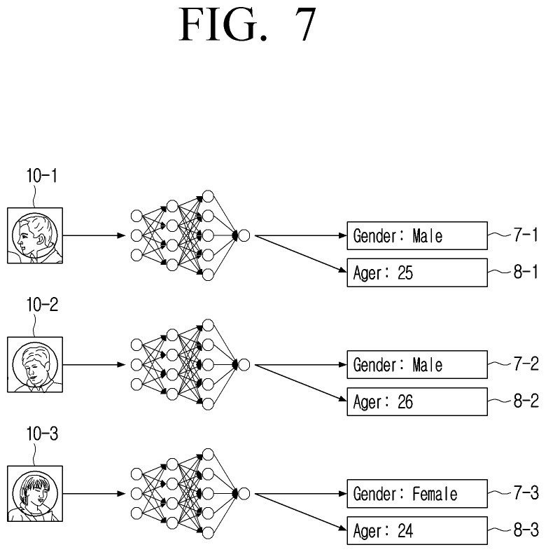

FIG. 7 is a view showing a method of obtaining gender and age according to an embodiment of the disclosure.

Referring to FIG. 7, the processor 120 can obtain various information from the captured image 10 by using the neural network model 1000.

For example, the processor 120 may input each of the plurality of person images 10-1 to 10-3, obtained from the captured image 10, to the neural network model 1000, to obtain the gender 7-1 and age 8-1 of the first person image 10-1, the gender 7-2 and age 8-2 of the second person image 10-2, and the gender 7-3 and age 8-3 of the third person image 10-3.

In addition, although not shown in FIG. 7, the processor 120 may input each of the plurality of person images 10-1 to 10-3 obtained from the captured image 10 to the neural network model 1000 to obtain emotion of the first person image 10-1, emotion of the second person image 10-2 and emotion of the third person image 10-3.

For another example, the processor 120 may input the plurality of person images 10-1 to 10-3, obtained from the captured image 10, to the neural network model 1000 to obtain an intimacy value of the plurality of person images 10-1 to 10-3.

In the above embodiment, the neural network model 1000 that outputs a gender 7, an age 8, the emotion, the intimacy value or the like may use a prior neural network model, or may use a neural network model trained to output the gender 7, the age 8, the emotion, the intimacy value or the like from the plurality of sample images.

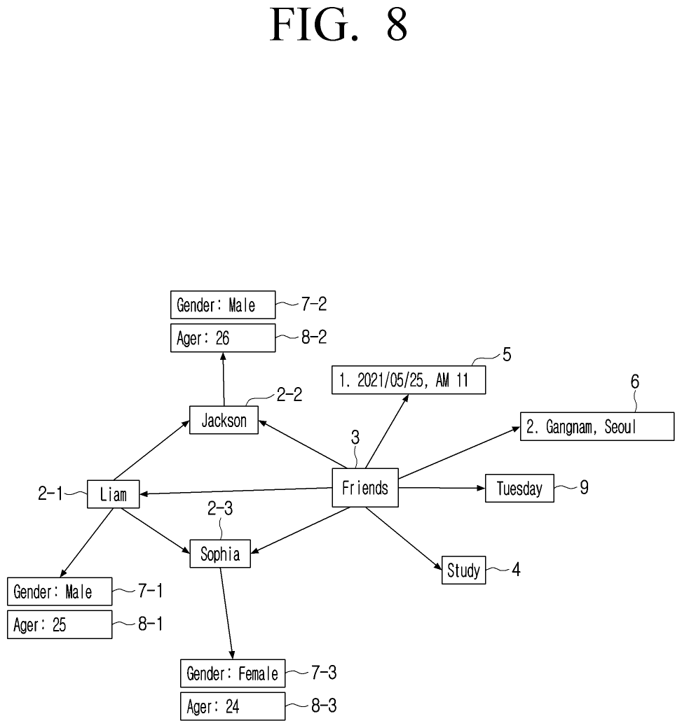

FIG. 8 is a view showing group information according to an embodiment of the disclosure.

FIG. 8 shows that, in addition to the group information shown in FIG. 3, the processor 120 may generate the group information by mapping the action type 4 shown in FIG. 5, the date and time 5 or the day and the place 6, shown in FIG. 6, and the gender 7 and age 8, shown in FIG. 7, and the like together.

Referring to FIG. 8, the processor 120 may use the metadata of the neural network model 1000 and the captured image 10 to generate the group information in which: the plurality of person images 10-1 to 10-3, obtained from the captured image 10, each correspond to the first identification information 2-1 to the third identification information 2-3; the relationship information 3 corresponds to the friend relationship; the action type 4 corresponds to the study; the captured date and time 5 or day 9 and place 6 correspond to May 25, 2021 at 11 am in Gangnam, Seoul; and each gender 7 and age 8 of the first identification information 2-1 to the third identification information 2-3 can be identified.

The group information shown in FIG. 8 is an example for explaining a case in which the group information has the graph form, and may not be limited thereto.

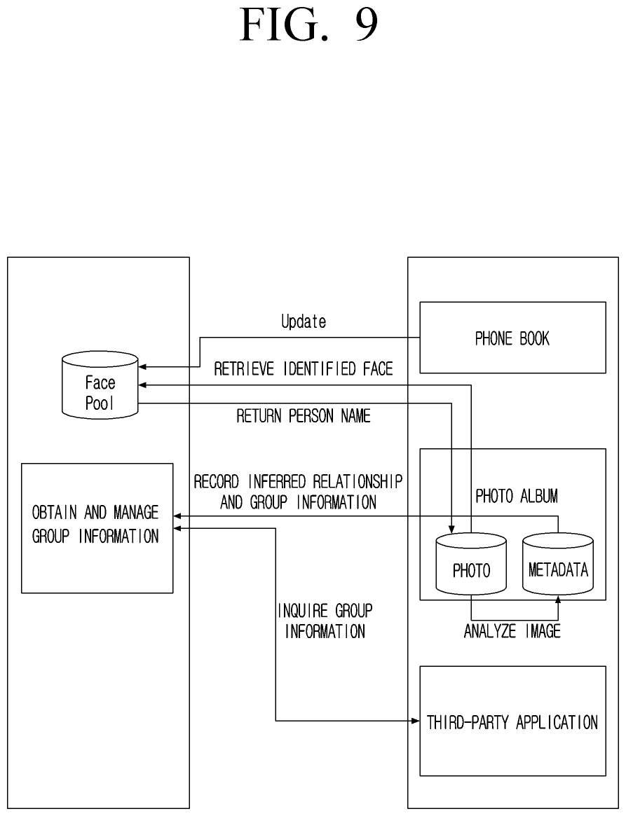

FIG. 9 is a view showing a method of obtaining the group information according to an embodiment of the disclosure.

Referring to FIG. 9, a flow is illustrated in which the processor 120 according to the above-described embodiment obtains the group information, and a third party application provides the processor 120 with the recommendation information, based on the group information.

The processor 120 may first obtain the image information (e.g., face pool) A corresponding to each of the plurality of persons by using data stored in the contact management application (e.g., phone book).

The processor 120 may then input the captured image 10, stored in the memory 110, i.e. a photo management application (e.g., photo album) to the neural network model 1000 to retrieve the person image information corresponding to the person included in the captured image 10. The processor 120 may then obtain the identification information mapped to the retrieved person image information. That is, the processor 120 can obtain the name (or nickname) of the person included in the captured image 10.

The processor 120 may obtain the group information by using the obtained name, and may provide the group information in response to a request from the third-party application (e.g., a request for inquiry about the group information). The third-party application can provide the processor 120 with the recommendation information, based on the received group information if the request is made.

Here, the third-party application may include the application that generates a scheduling event, the application that generates a message transmission event and the like, and may not be limited thereto. The third-party application may include any type of application installed or installable on the electronic apparatus 100.

For example, the third-party application may be the photo management application. Here, the processor 120 may identify the captured image including all the images, respectively corresponding to the first identification information 2-1 to the third identification information 2-3 included in the group information, among the plurality of captured images, based on the group information, and may assign a specific tag (e.g., relationship information 3, action type 4 or the like) to the identified captured image.

Meanwhile, the processor 120 can obtain and maintain the plurality of group information based on a combination of various identification information as well as just one group information.

In addition, the processor 120 may also delete the group information if a predetermined period of time is over after obtaining the corresponding group information.

Meanwhile, the processor 120 according to an embodiment of the disclosure may obtain the image information 1, the identification information 2, the relationship information 3, the action type 4, the date and time 5 or the day, the place 6 or the like, corresponding to the captured image 10, by using the third-party application in addition to the neural network model 1000.

For example, the processor 120 can use the captured date included in the metadata on the captured image 10 to identify a schedule written on the same date as the captured date in a scheduling application (e.g., To-do list application or calendar application). The processor 120 may then obtain the identification information 2, the relationship information 3, the action type 4, the date and time 5 or the day, the place 6 or the like, based on the identified schedule.

For example, if a schedule identified in the scheduling application is “Lunch with friends Liam, Jackson and Sophia,” the processor 120 may obtain each of “Liam, Jackson and Sophia” as the identification information 2, obtain “friends” as the relationship information 3, and identify “Lunch” as the action type 4.

For another example, the processor 120 can use the captured date included in the metadata on the captured image 10 to identify a chat history on the same date as the captured date in a chat application (e.g., SNS application). The processor 120 may then obtain the identification information 2, the relationship information 3, the action type 4, the date and time 5 or the day, the place 6 or the like, based on the identified chat history.

For example, if the identified chat history in the chat application is “Let's study with Jackson in Gangnam from 1 o'clock,” the processor 120 can obtain “Jackson” as the identification information 2, and identify “study” as the action type 4. For example, the processor 120 may perform natural language understanding (NLU) on the chat history to obtain the identification information 2, the relationship information 3, the action type 4, the date and time 5 or the day, the place 6 or the like, corresponding to the captured image 10.

That is, the processor 120 may input the captured image 10 to the neural network model 1000 to obtain the image information 1, the identification information 2, the relationship information 3, the action type 4, the date and time 5 or the day, the place 6 or the like, and may obtain the group information based thereon. However, the processor 120 may not be limited thereto. For another example, the processor 120 may obtain or predict the image information 1, the identification information 2, the relationship information 3, the action type 4, the date and time 5 or the day, the place 6 or the like, by using the metadata on the captured image 10. For another example, the processor 120 may use the metadata on the captured image 10 to extract or obtain the image information 1, the identification information 2, the relationship information 3, the action type 4, the date and time 5 or the day, the place 6 or the like from the third-party application, thereby obtaining the group information based thereon. Meanwhile, the processor 120 according to an embodiment of the disclosure may obtain the group information including the first identification information 2-1 to the third identification information 2-3 if at least one of the first identification information 2-1 to the third identification information 2-3, obtained from the captured image 10, corresponds to the user of the electronic apparatus 100, and may not obtain the group information including the first identification information 2-1 to the third identification information 2-3 if none of the first identification information 2-1 to the third identification information 2-3 corresponds to the user of the electronic apparatus 100. That is, the processor 120 according to an embodiment may obtain only the group information including the identification information 2 corresponding to the user of the electronic apparatus 100, and may not obtain group information that does not include the identification information 2 corresponding to the user.

Returning to FIG. 1, the memory 110 may include a read only memory (ROM), a random access memory (RAM, e.g., dynamic RAM (DRAM)), a synchronous DRAM (SDRAM), a double data rate SDRAM (DDR SDRAM)) or the like, and may be implemented together with the processor 120 in one chip.

The processor 120 and the memory 110 may operate a function related to the artificial intelligence according to the disclosure. The processor 120 may be one or more processors. In this case, each of the one or more processors may be a general-purpose processor such as a graphic processing unit (CPU), an application processor (AP) or a digital signal processor (DSP), a graphics-only processor such as a graphic processing unit (GPU) or a vision processing unit (VPU), or an artificial intelligence-only processor such as a neural processing unit (NPU). The one or more processors may control input data to be processed based on a predefined operation rule or the artificial intelligence model, stored in the memory 110. Alternatively, if the one or more processors are the artificial intelligence-only processors, the artificial intelligence-only processor may be designed to have a hardware structure specialized for processing a specific artificial intelligence model.

The predefined operation rule or the artificial intelligence model may be generated by learning. Here, to be generated by the learning may indicate that a basic artificial intelligence model is trained using a number of learning data, based on a learning algorithm, thereby generating the predefined operation rule or the artificial intelligence model, set to perform a desired feature (or purpose). Such learning may be performed on a device itself on which the artificial intelligence is performed according to the disclosure, or by a separate server and/or system. An example of the learning algorithm may include, supervised learning, unsupervised learning, semi-supervised learning or reinforcement learning, and may not be limited thereto.

The artificial intelligence model can include a plurality of neural network layers. The plurality of neural network layers may each have a plurality of weight values, and perform a neural network operation, based on a calculation between an operation result of a previous layer and the plurality of weights. The plurality of weight values of the plurality of neural network layers can be optimized by a trained result of the artificial intelligence model. For example, the plurality of weights may be updated during a learning process to reduce or minimize a loss or a cost value, obtained from the artificial intelligence model. The artificial neural network may include the deep neural network (DNN) such as the convolutional neural network (CNN), the deep neural network (DNN), the recurrent neural network (RNN), a restricted Boltzmann machine (RBM), a deep belief network (DBN), a bidirectional recurrent deep neural network (BRDNN) or a deep q-network, etc.

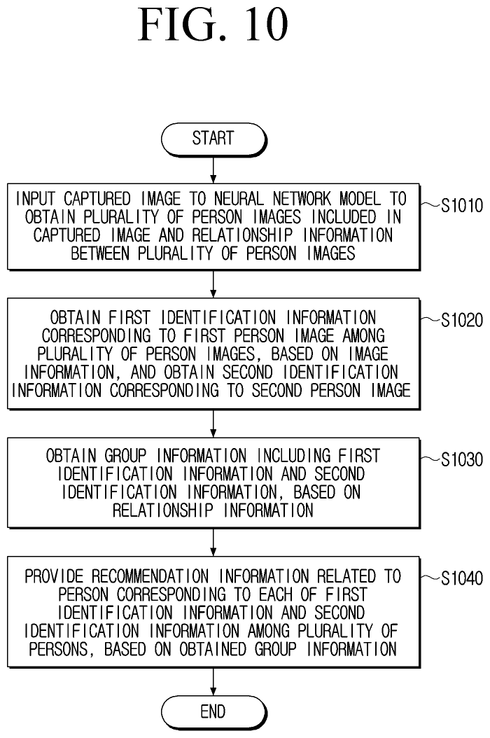

FIG. 10 is a flowchart showing a control method of the electronic apparatus according to an embodiment of the disclosure.

Referring to FIG. 10, a control method of an electronic apparatus including image information and identification information, corresponding to each of a plurality of persons, according to an embodiment of the disclosure first includes inputting a captured image to a neural network model to obtain a plurality of person images included in the captured image and relationship information between the plurality of person images at operation S1010.

The method may then include obtaining first identification information corresponding to a first person image and second identification information corresponding to a second person image, among the plurality of person images, based on the image information at operation S1020.

The method may then include obtaining group information including the first identification information and the second identification information, based on the relationship information at operation S1030.

The method may then include providing recommendation information related to the person corresponding to each of the first identification information and the second identification information among the plurality of persons, based on the obtained group information at operation S1040.

If an event including any one of the first identification information or the second identification information is generated in a specific application, based on a user command, the operation S1040 of providing the recommendation information according to an embodiment may include providing the rest of the first identification information or the second identification information as the recommendation information for the event.

Here, if a scheduling event including any one of the first identification information or the second identification information is generated in the specific application, based on the user command, the operation S1040 of providing the recommendation information may include providing the rest of the first identification information or the second identification information as the recommendation information for the scheduling event.

In addition, if an event for transmitting a message to any one of the first identification information or the second identification information is generated in the specific application, based on the user command, the operation S1040 of providing the recommendation information may include providing the rest of the first identification information or the second identification information as the recommendation information for sharing the message.

The control method according to an embodiment may further include identifying the captured image including all the images, respectively corresponding to the first identification information and the second identification information, among the captured images stored in the electronic apparatus, and managing the captured image by assigning a tag, corresponding to the obtained group information, to the identified captured image.

If the captured image including both the first person image and the second person image is identified among the plurality of captured images by a threshold number or more, the operation S1030 of obtaining the group information according to an embodiment may include obtaining the group information including the first identification information and the second identification information, based on the relationship information.

The neural network model according to an embodiment can be a model trained to obtain the relationship information between the plurality of person images, based on at least one of the attire, pose or facial expression of the person included in the plurality of person images or object information included in an input image, if the plurality of person images are identified in the input image.

The neural network model according to an embodiment may be a model trained to identify an action type corresponding to the input image, based on the relationship information between background information included in the input image and the person image included in the input image; and the control method according to an embodiment may further include obtaining action type information corresponding to the captured image by inputting the captured image to the neural network model, and managing the captured image by assigning the obtained action type information to the captured image, as a tag.

The control method according to an embodiment may further include obtaining at least one information on the place, date or time at which the captured image is captured, based on metadata included in the captured image, in which the providing of the recommendation information may include providing the obtained information as the recommendation information related to the person corresponding to each of the first identification information and the second identification information.

The operation S1030 of obtaining the group information according to an embodiment may include obtaining the group information including the first identification information or the second identification information if at least one of the first identification information or the second identification information corresponds to a user of the electronic apparatus, and may not include obtaining the group information including the first identification information or the second identification information if none of the first identification information or the second identification information corresponds to the user of the electronic apparatus.

Meanwhile, the various embodiments of the disclosure described above may be implemented in a computer or a computer readable recording medium by using software, hardware or a combination of the software and the hardware. In some cases, the embodiments described in the disclosure may be implemented by the processor itself According to a software implementation, the embodiments such as the procedure and the function described in the disclosure may be implemented by separate software modules. Each of the software modules may perform one or more functions and operations described in the disclosure.

Meanwhile, a computer instruction for performing a processing operation of the electronic apparatus 100 according to the various embodiments of the disclosure described above may be stored in a non-transitory computer-readable medium. The computer instruction stored in the non-transitory computer-readable medium may allow a specific device to perform the processing operation of the electronic apparatus 100 according to the various embodiments described above if the computer instruction is executed by a processor of the specific device.

The non-transitory computer-readable medium is not a medium that temporarily stores data, such as a register, a cache, a memory or the like, and may be a medium that semi-permanently stores data and that is readable by the machine. A specific example of the non-transitory computer-readable medium may include a compact disk (CD), a digital versatile disk (DVD), a hard disk, a blu-ray disk, a universal serial bus (USB), a memory card, a read only memory (ROM) or the like.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a memory configured to store image information and identification information, corresponding to each of a plurality of persons; and
a processor configured to:
input a captured image to a neural network model to obtain a plurality of person images included in the captured image and relationship information between the plurality of person images,
obtain first identification information corresponding to a first person image and second identification information corresponding to a second person image, among the plurality of person images, based on the image information,
obtain group information including the first identification information and the second identification information, based on the relationship information, and
provide recommendation information related to the person corresponding to each of the first identification information and the second identification information among the plurality of persons, based on the obtained group information.

2. The electronic apparatus as claimed in claim 1, wherein if an event including any one of the first identification information or the second identification information is generated in a specific application, based on a user command, the processor is further configured to provide the rest of the first identification information or the second identification information as the recommendation information for the event.

3. The electronic apparatus as claimed in claim 2, wherein if a scheduling event including any one of the first identification information or the second identification information is generated in the specific application, based on the user command, the processor is further configured to provide the rest of the first identification information or the second identification information as the recommendation information for the scheduling event.

4. The electronic apparatus as claimed in claim 2, wherein if an event for transmitting a message to any one of the first identification information or the second identification information is generated in the specific application, based on the user command, the processor is further configured to provide the rest of the first identification information or the second identification information as the recommendation information for sharing the message.

5. The electronic apparatus as claimed in claim 1, wherein the processor is configured to:
identify the captured image including all the images, respectively corresponding to the first identification information and the second identification information, among the captured images stored in the electronic apparatus; and
manage the captured image by assigning a tag, corresponding to the obtained group information, to the identified captured image.

6. The electronic apparatus as claimed in claim 1, wherein if the captured image including both the first person image and the second person image is identified among the plurality of captured images stored in the memory by a threshold number or more, the processor is further configured to obtain the group information including the first identification information and the second identification information, based on the relationship information.

7. The electronic apparatus as claimed in claim 1, wherein the neural network model is a model trained to obtain the relationship information between the plurality of person images, based on at least one of an attire, pose or facial expression of the person included in the plurality of person images or object information included in an input image, if the plurality of person images are identified in the input image.

8. The electronic apparatus as claimed in claim 1,
wherein the neural network model is a model trained to identify an action type corresponding to the input image, based on the relationship information between background information included in the input image and the person image included in the input image, and
wherein the processor is further configured to:
obtain action type information corresponding to the captured image by inputting the captured image to the neural network model, and
manage the captured image by assigning the obtained action type information to the captured image, as a tag.

9. The electronic apparatus as claimed in claim 1, wherein the processor is further configured to:
obtain at least one information on a place, date or time at which the captured image is captured, based on metadata included in the captured image; and
provide the obtained information as the recommendation information related to the person corresponding to each of the first identification information and the second identification information.

10. The electronic apparatus as claimed in claim 1, wherein the processor is further configured to:
obtain the group information including the first identification information or the second identification information if at least one of the first identification information or the second identification information corresponds to a user of the electronic apparatus; and
is configured not to obtain the group information including the first identification information or the second identification information if none of the first identification information or the second identification information corresponds to the user of the electronic apparatus.

11. A control method of an electronic apparatus including image information and identification information, corresponding to each of a plurality of persons, the control method comprising:
inputting a captured image to a neural network model to obtain a plurality of person images included in the captured image and relationship information between the plurality of person images;
obtaining first identification information corresponding to a first person image and second identification information corresponding to a second person image, among the plurality of person images, based on the image information;
obtaining group information including the first identification information and the second identification information, based on the relationship information; and
providing recommendation information related to the person corresponding to each of the first identification information and the second identification information, among the plurality of persons, based on the obtained group information.

12. The control method as claimed in claim 11, wherein if an event including any one of the first identification information or the second identification information is generated in a specific application, based on a user command, the providing of the recommendation information includes providing the rest of the first identification information or the second identification information as the recommendation information for the event.

13. The control method as claimed in claim 12, wherein if a scheduling event including any one of the first identification information or the second identification information is generated in the specific application, based on the user command, the providing of the recommendation information includes providing the rest of the first identification information or the second identification information as the recommendation information for the scheduling event.

14. The control method as claimed in claim 12, wherein if an event for transmitting a message to any one of the first identification information or the second identification information is generated in the specific application, based on the user command, the providing of the recommendation information includes providing the rest of the first identification information or the second identification information as the recommendation information for sharing the message.

15. The control method as claimed in claim 11, further comprising:
identifying the captured image including all the images respectively corresponding to the first identification information and the second identification information among the captured images stored in the electronic apparatus; and
managing the captured image by assigning a tag, corresponding to the obtained group information, to the identified captured image.

16. The control method as claimed in claim 11, wherein if the captured image including both the first person image and the second person image is identified among the plurality of captured images by a threshold number or more, obtaining the group information including the first identification information and the second identification information, based on the relationship information.

17. The control method as claimed in claim 11, wherein the neural network model is a model trained to obtain the relationship information between the plurality of person images, based on at least one of an attire, pose or facial expression of the person included in the plurality of person images or object information included in an input image, if the plurality of person images are identified in the input image.

18. The control method as claimed in claim 11,
wherein the neural network model is a model trained to identify an action type corresponding to the input image, based on the relationship information between background information included in the input image and the person image included in the input image, and
wherein the method further comprises:
obtaining action type information corresponding to the captured image by inputting the captured image to the neural network model; and
managing the captured image by assigning the obtained action type information to the captured image, as a tag.

19. The control method as claimed in claim 11,
wherein the method further comprising:
obtaining at least one information on a place, date or time at which the captured image is captured, based on metadata included in the captured image, and
wherein the providing the recommendation information comprises:
providing the obtained information as the recommendation information related to the person corresponding to each of the first identification information and the second identification information.

20. The control method as claimed in claim 11,
wherein the obtaining the group information comprises obtaining the group information including the first identification information or the second identification information if at least one of the first identification information or the second identification information corresponds to a user of the electronic apparatus, and
wherein the method does not obtain the group information including the first identification information or the second identification information if none of the first identification information or the second identification information corresponds to the user of the electronic apparatus.
